(19) United States
(12) Patent Application Publication
(10) Pub. No.: US 2001/0008046 A1
(43) Pub. Date: Jul. 19, 2001

(54) Level

(75) Inventors: Walter Horburger, Gotzis (AT); Wolfgang Scheyer, Gotzis (AT)

Correspondence Address: Friedrich Kueffner, Suite 1921, 342 Madison Avenue, New York, NY, 10173, US

(73) Assignee: Ing. Guido Scheyer SOLA-Messwerkzeuge Gesellschaft m.b.H. & Co.

(21) Appl. No.: 09/759,543

(22) Filed: Jan. 12, 2001

(30) Foreign Application Priority Data
Jan. 14, 2000 (AT) A 53/2000

(51) Int. Cl. G01C 9/00

(52) U.S. Cl. 33/365; 33/379

(57) ABSTRACT

A level includes a level body and at least one bubble level mounted in the level body. The level body is of a foamed metal. The foamed metal may be foamed aluminum. The level body may be provided with a coating of synthetic material. The level body has recesses for mounting the bubble levels.

### BACKGROUND OF THE INVENTION

1. Field of the Invention

The present invention relates to a level with a level body and at least on bubble level placed in the level body.

2. Description of the Related Art

Levels with level bodies of synthetic material, in which the synthetic material in the interior of the level body is foamed by adding an expanding or foaming agent when manufacturing the level body and is porous as a result, are known in the art. Compared to known levels with level bodies of a hollow aluminum section, such levels of synthetic material have the advantage that the bubble levels can be more easily fastened or attached to the level body. When the interior of a level body of synthetic material is filled out with foamed synthetic material, it is easily possible to provide appropriate recesses in the level body for fastening the bubble levels, wherein the bubble levels are glued in the recesses. When the level bodies are hollow aluminum sections, additional support devices for the bubble level are required, wherein mounting of the bubble level in the hollow aluminum section requires additional manufacturing steps when the level is produced.

However, levels of synthetic material have the disadvantage that they are not very accurate. When the level body cools after its manufacture, a certain shrinkage occurs which is not completely uniform along the axial direction of the level body. This results in inaccuracies of the measuring surface at the bottom side of the level body. For this reason, levels with level bodies of foamed synthetic material are manufactured with a length of only up to 80 cm, wherein the achievable tolerances of the planarity of the measuring surface are at about 0.3 mm. In contrast, level bodies of hollow aluminum sections are further processed or finished after the manufacture of the section in an alignment process for aligning the measuring surface. The achievable tolerances of the planarity of the measuring surface of levels of up to 2 m length are about 0.15 mm, and about 0.1 mm in the case of levels which are shorter than 80 cm. However, the alignment of the measuring surface in a further processing step results in additional expenses.

### SUMMARY OF THE INVENTION

Therefore, it is the primary object of the present invention to eliminate the disadvantages of the known level body and to make available a level which can be easily mass produced and has a high accuracy.

In accordance with the present invention, in a level of the above-described type, the level body is of a foamed metal.

Porous metal bodies of a foamed metal are known in the art. For example, such foamed metal bodies or methods of their production are described in U.S. Pat. No. 3,087,807, German Patent 4,101,630 and German Patent 4,018,360, so that they do not have to be explained in detail herein. The contents of these references are incorporated herein by reference.

It has surprisingly been found that, by constructing the level body as a foamed metal body, it is possible to manufacture an extremely accurate level which simultaneously can be very easily and inexpensively mass produced. Although a shrinkage occurs when the level body cools after its manufacture as is the case in level bodies of foamed synthetic material, this shrinkage is extremely uniform over the length of the level body so that a very accurate level is obtained in this manner without requiring any further processing of the measuring surface.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of a level body of a foamed metal; and

FIG. 2 is a schematic partial cross-sectional view of the level body of FIG. 1 taken along sectional line A-A.

### DESCRIPTION OF THE PREFERRED EMBODIMENTS

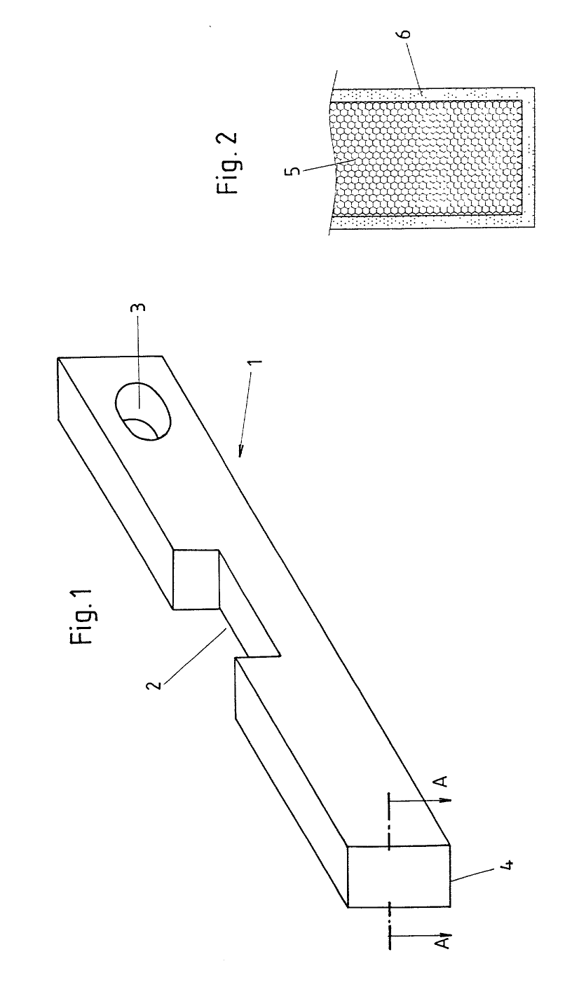

FIG. 1 of the drawing shows a level body 1 with recesses 2, 3. Bubble levels are placed and glued into the recesses in a subsequent production step. In addition, the level body 1 can be provided with a coating of synthetic material before or after the bubble levels have been placed in the recesses 2, 3. The measuring surface 4 located at the bottom side of the level body 1 has at a length of the level body 1 of 80 cm a tolerance with respect to its planarity of less than 0.1 mm.

In accordance with the present invention, the level body 1 is composed of a foamed metal, preferably of foamed aluminum. As schematically illustrated in FIG. 2, the embodiment of the spirit level body illustrated in the drawing has in the interior of the level body 1 a portion 5 of a highly porous foamed metal layer and surface portions 6 which are less porous or hardly porous. A method of manufacturing such bodies of a foamed metal is known, for example, from the above-mentioned German Patent 4,101,630.

Depending on the intended use of the level, the level body can have instead of the shape illustrated in FIG. 1 another shape suitable for a level and can be provided with recesses for bubble levels depending upon the number and desired configuration of the bubble levels.

While specific embodiments of the invention have been shown and described in detail to illustrate the inventive principles, it will be understood that the invention may be embodied otherwise without departing from such principles.

We claim:

1. A level comprising a level body and at least one bubble level mounted in the level body, wherein the level body is of a foamed metal.

2. The level according to claim 1, wherein the foamed metal is foamed aluminum.

3. The level according to claim 1, wherein the level body has a coating of synthetic material.

4. The level according to claim 1, wherein the level body has recesses for the bubble levels.

5. The level according to claim 1, wherein the level body has an inner portion of highly porous metal and portions adjacent surfaces of the level body which are of a less or hardly porous metal and form an essentially closed outer skin.
